(19) United States
(12) Patent Application Publication
(10) Pub. No.: US 2024/0061187 A1
(43) Pub. Date: Feb. 22, 2024

(54) MULTI-FIBER FERRULE WITH TAPERED TRANSITION INTO FERRULE BORE

(71) Applicants: CORNING RESEARCH & DEVELOPMENT CORPORATION, Corning, NY (US); US CONEC LTD., Hickory, NC (US)

(72) Inventors: John Joseph Costello, III, Circle Pines, MN (US); Jeffrey Dean Daniey, Hickory, NC (US); Michael De Jong, Colleyville, TX (US); Daniel Kurtz, Huntersville, NC (US); Charles Gregory Stroup, JR., Lincolnton, NC (US); Wayne James Zyglocke, Hickory, NC (US)

(21) Appl. No.: 18/235,488

(22) Filed: Aug. 18, 2023

Related U.S. Application Data
(60) Provisional application No. 63/399,814, filed on Aug. 22, 2022.

(51) Int. Cl. G02B 6/38; G02B 6/44

(52) U.S. Cl. CPC G02B 6/3885; G02B 6/3829; G02B 6/448

(57) ABSTRACT

The present disclosure relates to a multi-fiber ferrule having a plurality of bores where each bore has an adjacent divider that separates the bores. The divider also facilitates insertion of an optical fiber into each bore.

### PRIORITY APPLICATION

This application claims the benefit of priority of U.S. Provisional Application No. 63/399,814, filed on Aug. 22, 2022, the content of which is relied upon and incorporated herein by reference in its entirety.

### FIELD OF DISCLOSURE

This disclosure relates generally to optical fibers, and more particularly to ferrules for multi-fiber optical connectors, along with optical connectors and cable assemblies including such ferrules, and methods relating to these components.

### BACKGROUND

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, optical connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using “field-installable” connectors).

Many different types of optical connectors exist. In environments that require high density interconnects and/or high bandwidth, such as datacenters, multi-fiber optical connectors are the most widely used. One example is the multi-fiber push on (MPO) connector, which incorporates a mechanical transfer (MT) ferrule and is standardized according to TIA-604-5 and IEC 61754-7. These connectors can achieve a very high density of optical fibers, which reduces the amount of hardware, space, and effort to establish a large number of interconnects.

Despite the widespread use of MPO connectors in datacenter environments, there are still challenges/issues to address. For example, insertion of optical fibers into MPO connectors can be challenging. Ferrules for MPO connectors can have features that either (1) stop optical fibers, upon insertion into the ferrule, thereby not allowing the optical fibers to advance through the ferrule microholes, or (2) allow the optical fibers, upon insertion into the ferrule, to cross over into adjacent ferrule microholes such that one optical fiber does not correspond to each ferrule microhole.

Additionally, securing the optical fibers in the ferrule of an MPO connector can be a challenge. An adhesive material is typically used for this purpose, with adhesive material being injected or otherwise supplied into an internal cavity of the ferrule. There must be sufficient adhesive material to ensure that the optical fibers are sufficiently bonded/secured to the ferrule. To avoid uncertainty on whether a sufficient amount of adhesive material is supplied, there may be a tendency to completely fill the internal cavity of the ferrule. Doing so, however, may increase the likelihood of the adhesive material being disposed on an exterior of the ferrule or otherwise exiting the ferrule, both of which may interfere with the normal operation of the ferrule as part of an optical connector.

New multifiber ferrule and connectors designs have been proposed, such as smaller multifiber ferrules and very small form factor connectors including such ferrules. However, fiber insertion and adhesion challenges remain with the structural features of these new ferrule designs.

Improvements in the foregoing are desired.

### SUMMARY

The present disclosure relates to a multi-fiber ferrule having a plurality of bores where each bore has an adjacent divider that separates the bores. The divider also facilitates insertion of an optical fiber into each bore.

In one embodiment, a ferrule for an optical connector configured to accept a plurality of optical fibers. The ferrule comprising: a body having a front end and a back end, the body extending in a longitudinal direction between the front end and the back end; a plurality of bores extending into the body from the front end toward the back end, wherein each bore is configured to receive one of the plurality of optical fibers; a plurality of tapered dividers wherein each tapered divider has: a first end adjacent to a respective bore of the plurality of bores and a second end proximal to the back end of the ferrule; a cross-sectional shape at the first end that spans a circumference of the respective bore such that each of the plurality of bores are separated from each other; and tapered surfaces from the second end to the first end.

In another embodiment, the back end of the ferrule includes an indicia whereby the indicia provides a visual indicator of horizontal alignment of the plurality of optical fibers within the plurality of bores of the ferrule. In another embodiment, the indicia extends from the back end of the ferrule to the second end of the tapered divider. In another embodiment, the tapered divider has a height H1 at a first end and a height H2 at the second end, wherein a height ratio H2:H1 ranges between 1.2:1 and 3:1. In another embodiment, the tapered divider has a width W1 at a first end and a width W2 at the second end, wherein a width ratio W2:W1 ranges between 1.2:1 and 3:1. In another embodiment, the tapered divider has a circular cross section at the first end and a square cross section at the second end. In another embodiment, the tapered surface of the tapered divider has an angle ranging between 15° and 45° relative to a longitudinal axis of one of the bores. In another embodiment, adjacent tapered dividers have corresponding adjacent tapered surfaces that form an edge, wherein the edge is configured to prevent an optical fiber from being inserted into a non-corresponding bore. In another embodiment, the second end of the tapered divider is flush with the back end of the ferrule. In another embodiment, the plurality of bores comprises a first row of bores and a second row of bores spaced from the first row of bores, wherein the first row of bores are coplanar with each other and the second row of bores are coplanar with each other. In another embodiment, the first row of bores and the second row of bores are separated by a spacer that is flush with the back end of the ferrule, and wherein the spacer is integrally formed with the ferrule. In another embodiment, the ferrule further comprises a window formed on a top surface or a bottom surface of the ferrule, wherein the window extends into a lead-in section of the ferrule adjacent to the tapered divider.

In another embodiment, optical connector, comprising: a ferrule according to any of the embodiments; and a plurality of optical fibers secured to the ferrule, wherein each optical fiber extends from the back end of the body and into one of the microholes. In another embodiment, the plurality of bores comprises a first row of bores and a second row of bores spaced from the first row of bores, wherein the first row of bores are coplanar with each other and the second row of bores are coplanar with each other. In another embodiment, the plurality of optical fibers comprises a first ribbon of optical fibers and a second ribbon of optical fibers, wherein the first ribbon of optical fibers and the second ribbon of optical fibers are coplanar with each other; and wherein the first ribbon of optical fibers and the second ribbon of optical fibers are separated by an optical fiber spacer; wherein the first ribbon of optical fibers, the second ribbon of optical fibers, and the optical fiber spacer are inserted into the back end of the ferrule such that the first ribbon of optical fibers are inserted into the first row of bores and the second ribbon of optical fibers are inserted into the second row of bores. In another embodiment, the first row of bores and the second row of bores are separated by a spacer that is flush with the back end of the ferrule, and wherein the spacer is integrally formed with the ferrule. In another embodiment, the plurality of optical fibers comprises a first ribbon of optical fibers and a second ribbon of optical fibers, wherein the first ribbon of optical fibers and the second ribbon of optical fibers are coplanar with each other; and wherein the first ribbon of optical fibers and the second ribbon of optical fibers are inserted into the back end of the ferrule such that the first ribbon of optical fibers are inserted into the first row of bores and the second ribbon of optical fibers are inserted into the second row of bores.

In another embodiment, a method of terminating a plurality of optical fibers with the ferrule of any of the embodiments, comprising: aligning the optical fibers with the bores of the ferrule; and extending the optical fibers through the back end of the ferrule and into the bores, wherein the tapered divider provides that one optical fiber extends through each of the bores. In another embodiment, the aligning step comprises: aligning a first ribbon of optical fibers with a first row of bores; and aligning a second ribbon of optical fibers with a second row of bores. In another embodiment, the aligning the first ribbon of optical fibers includes aligning an optical fiber of the first ribbon with an indicia on a back end of the ferrule; and wherein the aligning the second ribbon of optical fibers includes aligning an optical fiber of the second ribbon with the indicia on the back end of the ferrule. In another embodiment, the first ribbon of optical fibers and the second ribbon of optical fibers are separated by an optical fiber spacer that is inserted into the ferrule with the first ribbon of optical fibers and the second ribbon of optical fibers. In another embodiment, the method, further comprising: supplying an adhesive into the tapered divider. In another embodiment, the adhesive is supplied to the bores through a window formed in a top surface of the ferrule and extending into a lead in section of the ferrule adjacent to the tapered divider.

Additional features and advantages will be set forth in the detailed description which follows, and in part will be readily apparent to those skilled in the technical field of optical communications. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 a perspective view of an example of an optical connector;

FIG. 2 is an exploded perspective view of the optical connector of FIG. 1;

FIG. 3 is a front, perspective view of a ferrule used in the optical connector of FIG. 1 in accordance with the present disclosure;

FIG. 4 is a rear, perspective view of the ferrule of FIG. 3;

FIG. 5 is an enlarged rear view of the ferrule of FIG. 4;

FIG. 6 is a cross-sectional perspective view of the ferrule of FIG. 5;

FIG. 7 is a rear, perspective view of an alternate embodiment of a ferrule in accordance with the present disclosure;

FIGS. 7A-7C are cross-sectional views of the ferrule of the present disclosure with an optical fiber illustrating the locations of a bonding agent

FIG. 8A is a rear perspective view of the ferrule of FIG. 3 prior to inserting optical fibers within the ferrule in accordance with the present disclosure;

FIG. 8B is a rear perspective view of the ferrule of FIG. 8A after insertion of optical fibers within the ferrule in accordance with the present disclosure;

FIG. 9A is a rear perspective view of an alternate embodiment of the ferrule of FIG. 3 prior to inserting optical fibers within the ferrule in accordance with the present disclosure; and

FIG. 9B is a rear perspective view of the ferrule of FIG. 8A after insertion of optical fibers within the ferrule in accordance with the present disclosure;

FIG. 10 is an exploded view of the ferrule of the present disclosure and a converter coupled to the ferrule in accordance with the present disclosure;

FIG. 11 is a perspective view of the ferrule and the converter of FIG. 10 where the ferrule and the converter are coupled together;

FIG. 12 is a cross sectional view of the coupled ferrule and converter of FIG. 11;

FIG. 13 is a rear view of the coupled ferrule and converter of FIG. 11;

FIG. 14 is a perspective of an alternative embodiment of a converter coupled to the ferrule in accordance with the present disclosure;

FIG. 15 is a cross sectional view of the coupled ferrule and converter of FIG. 13; and

FIG. 16 is a rear perspective view of the ferrule and the converter of FIG. 13.

### DETAILED DESCRIPTION

Various embodiments will be further clarified by examples in the description below. In general, the description relates to multi-fiber ferrules and fiber optic connectors and cable assemblies incorporating such multi-fiber ferrules. In particular, the present disclosure relates to a multi-fiber ferrule having a plurality of bores where each bore has an adjacent divider that separates the bores. The divider also facilitates insertion of an optical fiber into each bore.

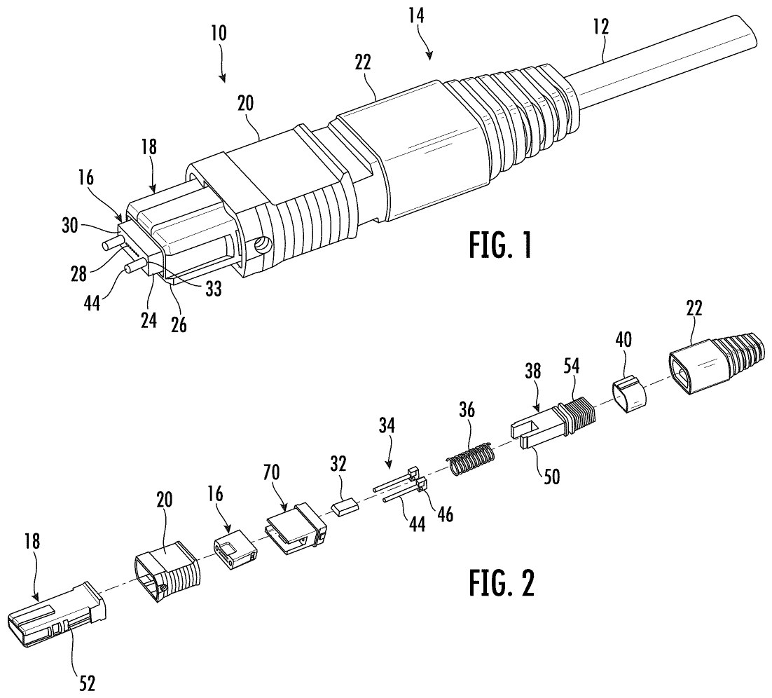

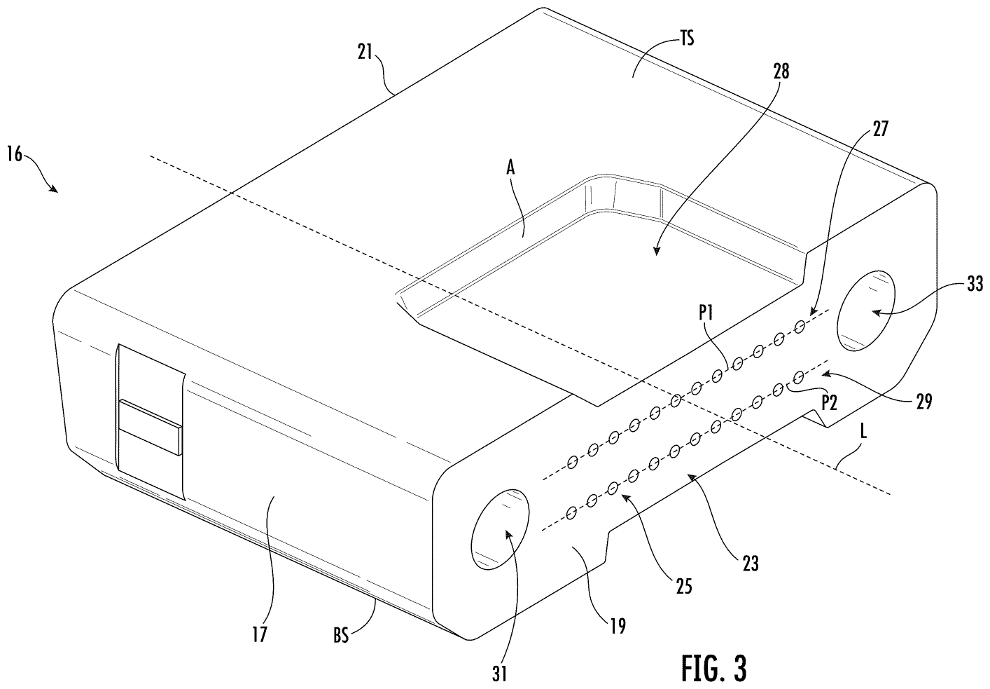

The fiber optic connectors may be based on known connector designs, such as MPO connectors. To this end, FIGS. 1 and 2 illustrate a fiber optic connector 10 (also referred to as “optical connector” or simply “connector”) in the form of an MTP® connector, which is particular type of MPO connector (MTP® is a trademark of US Conec Ltd.). A brief overview of the connector 10 will be provided to facilitate discussion, as the multi-fiber ferrules and other components shown in subsequent figures may be used in connection with the same type of connector as the connector 10. However, persons skilled in the field of optical connectivity will appreciate that the connector 10 is merely an example, and that the general principles disclosed with respect to the multi-fiber ferrules and other components shown in subsequent figures may also be applicable to other connector designs.

As shown in FIG. 1, the connector 10 may be installed on a fiber optic cable 12 (“cable”) to form a fiber optic cable assembly 14. The connector includes a ferrule 16, a housing 18 received over the ferrule 16, a slider 20 received over the housing 18, and a boot 22 received over the cable 12. The ferrule 16 is spring-biased within the housing 18 so that a front portion 24 of the ferrule 16 extends beyond a front end 26 of the housing 18. As discussed in greater detail herein, ferrule 16 is also coupled to a converter 80 to increase the size of ferrule 16 so that ferrule 16 is compatible in certain connector configurations. Optical fibers (not shown) carried by the cable 12 extend through microholes or bores 25 in the ferrule 16 before terminating at or near an end face 30 of the ferrule 16. The optical fibers are secured within the ferrule 16 using an adhesive material (e.g., epoxy) and can be presented for optical coupling with optical fibers of a mating component (e.g., another fiber optic connector; not shown) when the housing 20 is inserted into an adapter, receptacle, or the like.

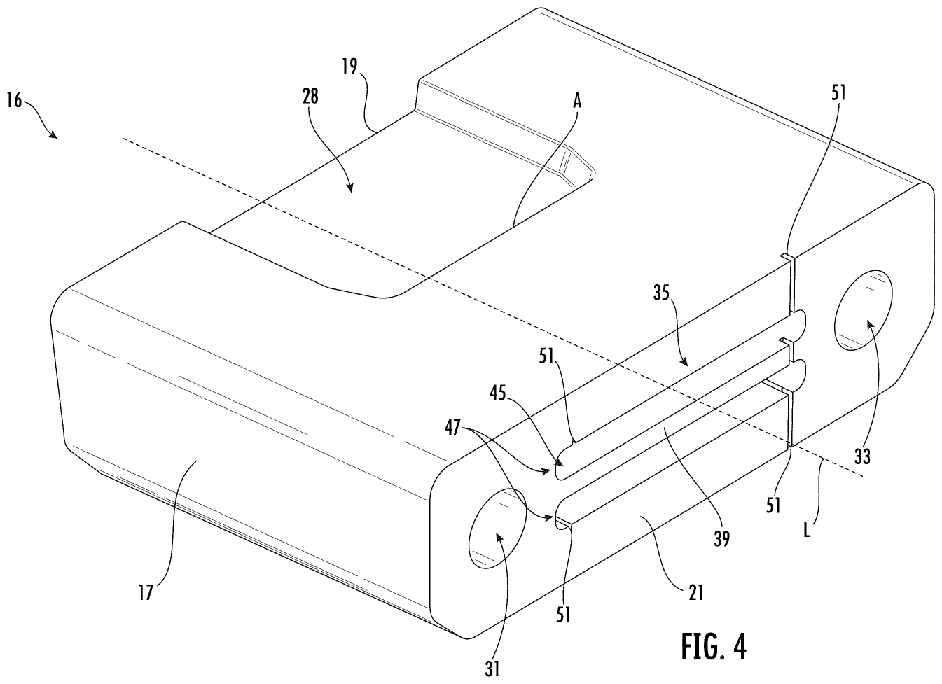

As shown in FIG. 2, the connector 10 also includes a ferrule boot 32, guide pin assembly 34, spring 36, crimp body 38, and crimp ring 40. The ferrule boot 32 is received in a rear portion 42 of the ferrule 16 to help support the optical fibers extending to the ferrule bores 25 (FIG. 3). The guide pin assembly 34 includes a pair of guide pins 44 extending from a pin keeper 46. Features on the pin keeper 46 cooperate with features on the guide pins 44 to retain portions of the guide pins 44 within the pin keeper 46. When the connector 10 is assembled, the pin keeper 46 is positioned against a back surface of the ferrule 16, and the guide pins 44 extend through pin holes 31, 33 (FIG. 3) provided in the ferrule 16 so as to project beyond the front end face 30.

Both the ferrule 16 and guide pin assembly 34 are biased to a forward position relative to the housing 18 by the spring 36. More specifically, the spring 36 is positioned between the pin keeper 46 and a portion of the crimp body 38. The crimp body 38 is inserted into the housing 18 when the connector 10 is assembled and includes latching arms 50 that engage recesses 52 in the housing. The spring 36 is compressed by this point and exerts a biasing force on the ferrule 16 via the pin keeper 46. The rear portion 42 of the ferrule defines a flange that interacts with a shoulder or stop formed within the housing 18 to retain the rear portion 42 within the housing 18.

In a manner not shown in the figures, aramid yarn or other strength members from the cable 12 are positioned over an end portion 54 of the crimp body 38 that projects rearwardly from the housing 18. The aramid yarn is secured to the end portion 54 by the crimp ring 40, which is slid over the end portion 54 and deformed after positioning the aramid yarn. The boot 22 covers this region, as shown in FIG. 1, and provides strain relief for the optical fibers by limiting the extent to which the connector 10 can bend relative to the cable 12.

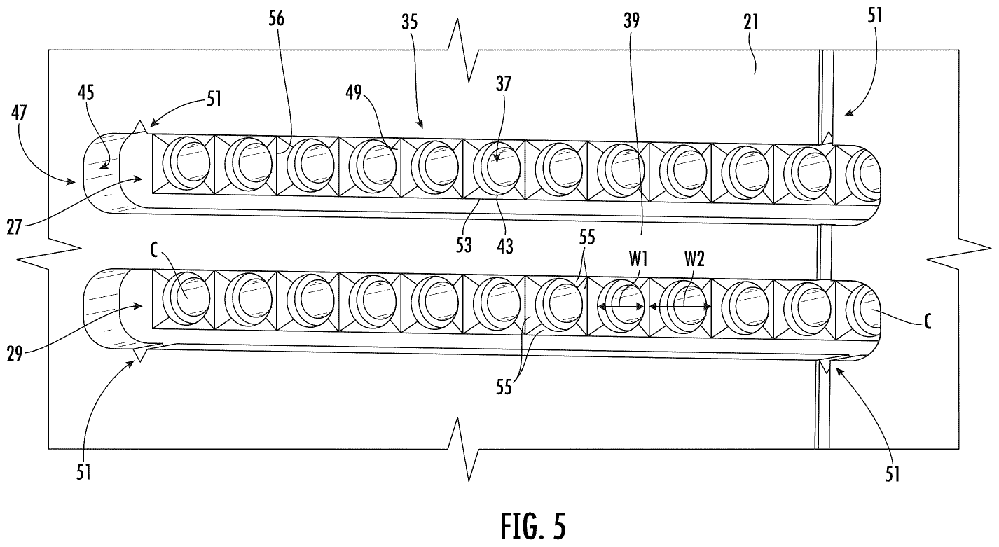

Now that a general overview of the connector 10 has been provided, ferrule designs will be described. To this end, FIGS. 3 and 4 illustrate ferrule 16 to be used in accordance with connector 10. Ferrule 16 is shown as a miniature MT ferrule that is smaller than a conventional MT ferrule. A similar ferrule is disclosed in WO2021217050A1, the disclosure of which is incorporated by reference. However, ferrule 16 as shown is merely an illustrative example and aspects of this disclosure may apply to conventional MT ferrules for MPO connectors or other multifiber ferrule designs.

Ferrule 16 includes a ferrule body 17 extending in a longitudinal direction (i.e., along a longitudinal axis L) between front and back ends 19, 21 of the ferrule body 17. The front end 19 of the ferrule body 17 defines an end face 23 where microholes 25 are included.

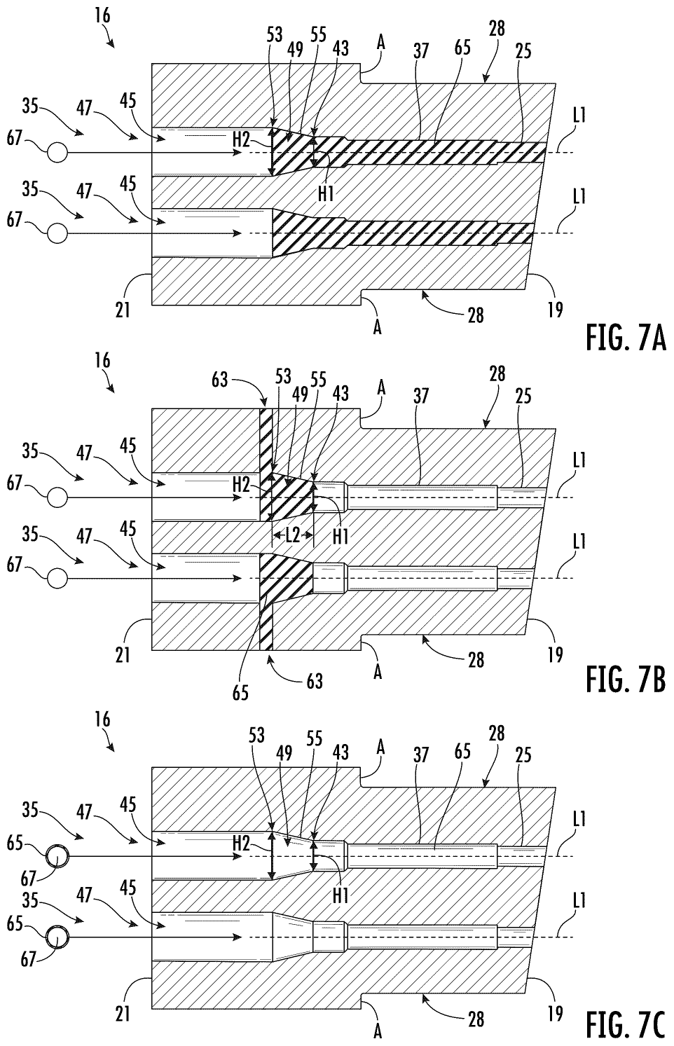

As shown in FIG. 3, ferrule 16 includes first and second groups 27, 29 of microholes 25 extending into ferrule body 17 from front end 19 where microholes 25 of groups 27 are coplanar with each other—plane P1—and microholes 25 of group 29 are coplanar with each other—plane P2. Each microhole 25 is configured to receive an optical fiber 67 (FIGS. 7A-7C). In the embodiment shown, there are twelve microholes 25 in each of the first and second groups 27, 29. However, it is within the scope of the present disclosure that alternate groupings and number of microholes 25 may be used with ferrule 16 (e.g., one row of 12 microholes, etc.). Ferrule 16 also includes a recessed portion 28 on a top surface 32 of ferrule 16. In particular, as shown, recessed portion 28 is defined by a ledge A on a top surface TS of ferrule 16. As discussed in greater detail herein, ledge A is configured to couple to a converter 80 to form ferrule assembly 70. Recessed portion 28 and ledge A are also provided on a bottom surface BS of ferrule 16. However, it is within the scope of the present disclosure that in alternate embodiments, ledge A and recessed portion 28 can be provided on either top surface TS or bottom surface BS individually.

Ferrule 16 also includes pin holes 31, 33 that are configured to receive guide pins when mounting ferrule 16 within a connector 10. In FIGS. 3 and 4, as shown, pin holes 31, 33 are empty such that the embodiment represents a female configuration of the ferrule 16. For a male configuration, respective guide pins may be received in pin holes 31, 33 and may project beyond a front end 19 of ferrule 16. Although two pin holes 31, 33 are shown in the figures, any number of pin holes 31, 33 may be provided in alternative embodiments.

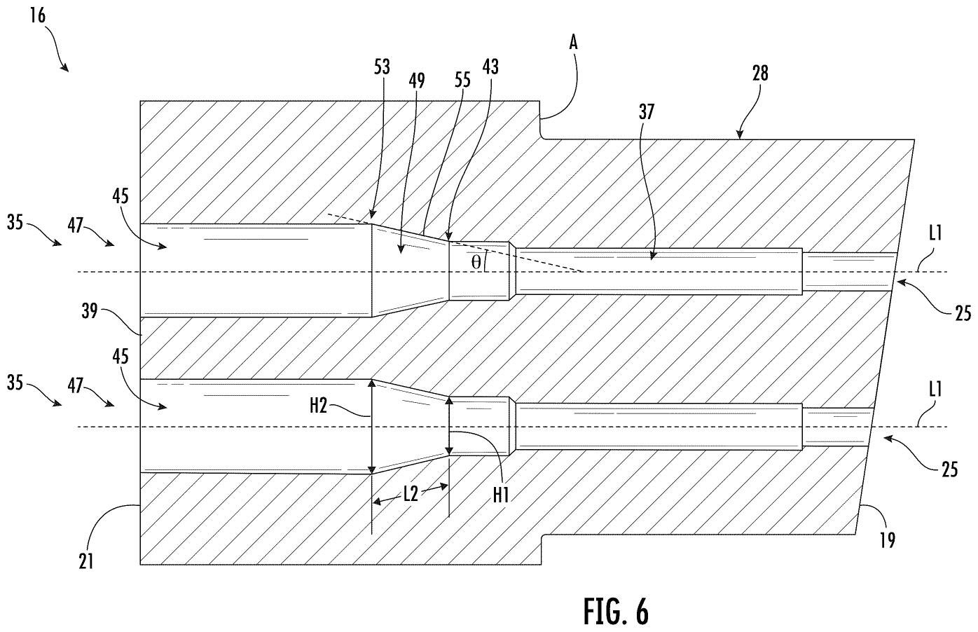

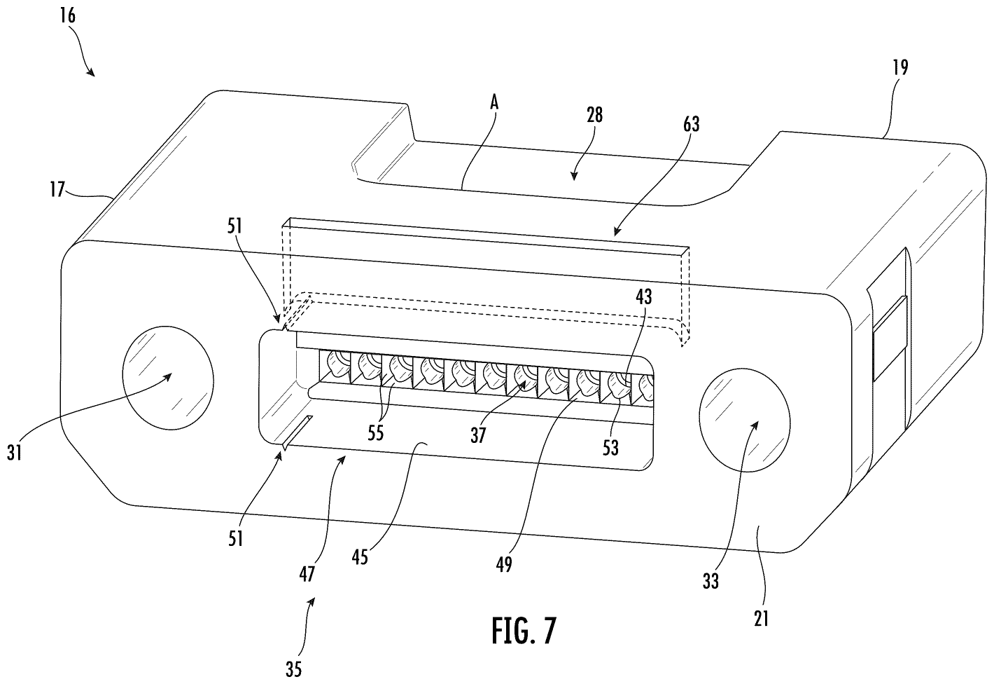

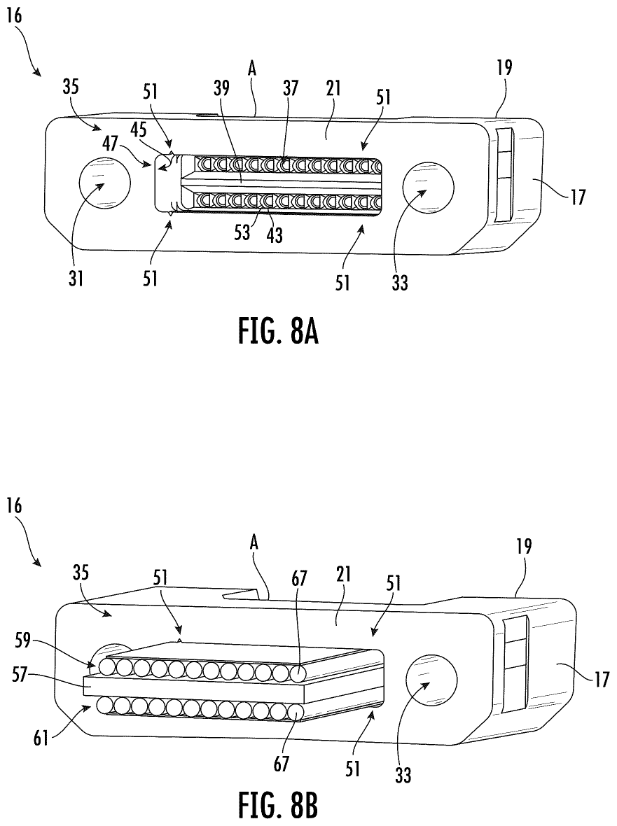

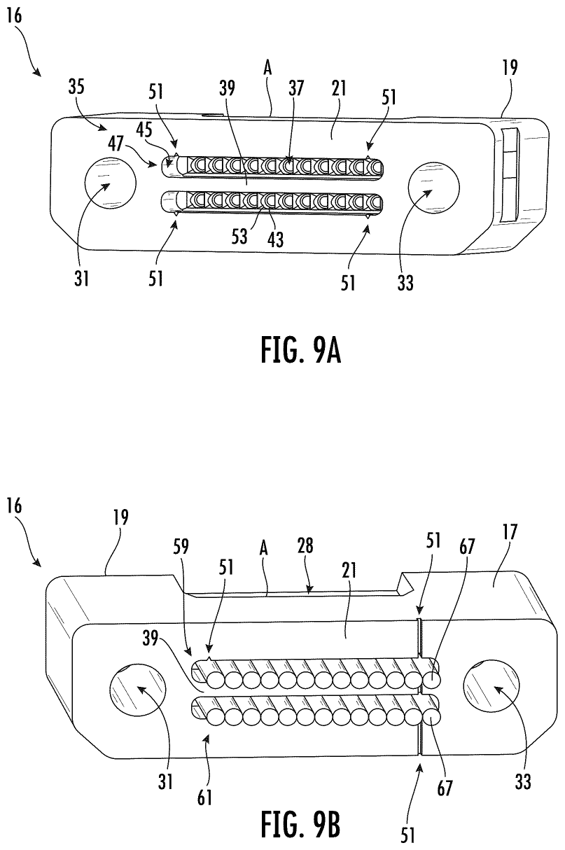

Referring now to FIGS. 4 and 5, the back end 21 of ferrule 16 is shown where back end 21 includes a lead in section 35 that provides access to bores 37 within ferrule body 17 that extend to the front end 19 of ferrule 16. In some embodiments, bore 37 includes a microhole 25 that extends into the ferrule body 17 from front end 19 of ferrule 16. In particular, with brief reference to FIG. 6, bores 37 are adjacent to microholes 25, and as shown, each of the bores 37 has a greater diameter than microhole 25. Moreover, in some embodiments, bore 37 can increase in diameter as bore 37 approaches back end 21 as shown. However, it is within the scope of the present disclosure that bore 37 has a uniform diameter within ferrule body 17 of ferrule 16. As mentioned previously, there are two groups 27, 29 of microholes 25, and as such, there are two groups 27, 29 of bores 37 that correspond to the groups of microholes 25. Groups 27, 29 are separated by a spacer 39. Spacer 39 is configured to separate groups 27, 29 of bores 37 to facilitate insertion of optical fibers into the bores 37. In particular, spacer 39 prevents optical fibers 67 (FIG. 7A-7C) or optical fiber ribbons 59, 61 (FIGS. 8 and 9) from being inserted into the incorrect group of bores 37. In some embodiments, spacer 39 is integrally formed with ferule 16 and is flush with back end 21. However, in alternate embodiments, spacer 39 is not included in the design of ferrule 16. In another alternate embodiment, spacer 39 is included in the lead in section 35 of ferrule 16 and is integrally formed with ferrule 16, but spacer 39 is not flush with back end 21 of ferrule 16. Additional details regarding the back end 21 of ferrule 16 are discussed in greater detail below.

Referring now to FIG. 5, an enlarged view of lead in section 35 of back end 21 is shown. As mentioned previously, lead in section 35 provides access to bores 37 within ferrule 16. As shown, lead in section 35 includes a channel 45 and an aperture 47 extending from back end 21 of ferrule 16 to tapered divider 49. In some embodiments, lead in section 35 only includes an aperture 47 where tapered divider 49 is flush with the aperture 47 and no channel is provided. In some embodiments, aperture 47 of lead in section 35 is flush with back end 21. In some embodiments, aperture 47 is recessed with respect to back end 21. Aperture 47 provides access to tapered divider 49 and is shaped to encompass bores 37 and tapered dividers 49. Aperture 47 also includes at least one indicia 51. Indicia 51 is configured to provide a reference point for an installer when installing an optical fiber ribbon 59, 61 (FIGS. 8 and 9) or optical fiber(s) 67 (FIGS. 7A-7C). In particular, indicia 51 provides a visual indicator to horizontally align the optical fibers 67 or optical fiber ribbons 59, 61 within aperture 47. Moreover, the indicia 51 can extend to tapered divider 49 and bore 37 such that indicia 51 aligns with a center C of bore 37. In this configuration, indicia 51 also provides a visual indicator to align an end fiber of an optical fiber ribbon 59, 61 such that the end optical fiber of the optical fiber ribbon 59, 61 aligns with the end bore 37. In some embodiments, indicia 51 is an indentation on back end 21 of ferrule 16. In some embodiments, indicia 51 is a protrusion on back end 21 of ferrule 16. In some embodiments, as shown, indicia 51 comprises a mark extending from one of apertures 47 along the back end 21 toward either a top surface or a bottom surface of the ferrule 16, where the mark comprises a portion of the back end 21. In some embodiments, as also shown, indicia 51 comprises a mark that spans from one of apertures 47 and extends to either the top surface or the bottom surface of ferrule 16 or both.

When optical fibers 67 or optical fiber ribbons 59, 61 are inserted into aperture 47, the optical fiber(s) engage with tapered divider 49 prior to entering bore 37. With reference to FIGS. 5 and 6, tapered divider 49 is configured to provide a physical barrier such that optical fibers are directed into the corresponding bore 37 and optical fiber crossover is avoided. As used herein, optical fiber crossover refers to where an optical fiber 67 that corresponds to a particular bore 37 “crosses over” into a different bore 37 that does not correspond to the optical fiber.

As shown, tapered divider 49 comprises a first end 43 adjacent to bore 37 and a second end 53 proximal to back end 21 with tapered surfaces 55 spanning from first end 43 to second end 53. At first end 43, tapered divider 49 has a cross sectional shape that is coaxial with longitudinal axis L1 of bore 37. Stated another way, the cross section of tapered divider 49 at first end 43 spans the circumference of bore 37 and is coaxial with bore 37. In some embodiments, the cross-section shape of tapered divider 49 at first end 43 is circular where the cross section is coaxial with bore 37. However, it is within the scope of the present disclosure that in alternate embodiments, alternate suitable cross section shapes may be used. In some embodiments, tapered divider 49 has a length L2 that is less than 250 microns.

As shown, at first end 43, tapered divider 49 has a height H1 ranging between 100 microns and 250 microns, between 100 microns and 150 microns, or between 125 microns and 150 microns. Tapered divider 49 also has a width W1 ranging between 100 microns and 250 microns, between 100 microns and 150 microns, or between 100 microns and 125 microns at first end 43. In some embodiments, first end 43 of tapered divider 49 is adjacent to bore 37 of ferrule 16.

At second end 53, tapered divider 49 has a cross sectional shape that is coaxial with longitudinal axis L1 of bore 37. Stated another way, the cross section of tapered divider 49 at second end 53 spans the circumference of bore 37 and is coaxial with bore 37. In some embodiments, the cross-section shape of tapered divider 49 at second end 53 is square where the cross section is coaxial with bore 37. However, it is within the scope of the present disclosure that in alternate embodiments, alternate suitable cross section shapes may be used. As shown, at second end 53, tapered divider 49 has a height H2 ranging between 200 microns and 800 microns, between 200 microns and 500 microns, or between 200 microns and 250 microns. Tapered divider 49 also has a width W2 ranging between 150 microns and 350 microns at second end 53. In some embodiments, width W2 of tapered divider 49 is equal to the pitch between bores 37. As used herein, “pitch” refers to the distance from a center of one bore 37 to a center of another adjacent bore 37. In some embodiments, second end 53 of tapered divider 49 is within lead in section 35. In some embodiments, second end 53 of tapered divider 49 is flush with back end 21 of ferrule 16.

In some embodiments, a height ratio H2:H1 from second end 53 to first end 43 ranges between 1.2:1 and 3:1. In some embodiments, a width ratio W2:W1 from second end 53 to first end 43 ranges between 1.2:1 and 3:1.

As mentioned previously, tapered surfaces 55 are provided between first end 43 and second end 53 of tapered divider 49. Tapered surfaces 55 connect first end 43 to second end 53 of tapered divider 49, and tapered surfaces 55 are angled with respect to longitudinal axis L1 of bore 37 and are configured to guide inserted optical fibers into bore 37. In particular, when optical fibers 67 are inserted through the second end 53 of tapered divider 49, optical fibers 67 may be off center with respect to corresponding center C of bore 37 and contact one of tapered surfaces 55. The tapered surface 55 then guides optical fiber 67 into bore 37 as optical fiber 67 is continued to be advanced within bore 37. In some embodiments, tapered surfaces 55 have an angle θ ranging between 15° and 45°. Having an angled tapered surface as shown provides the advantage of a softer vertical wall where optical fibers that are off center with center C of bore 37 are guided into alignment as the optical fiber 67 is advanced through ferrule 16. This configuration facilitates insertion of optical fibers into bores 37 and improves installation time as optical fibers are directed into bores 37. This contrasts with previous ferrule configurations where a vertical wall substantially perpendicular with longitudinal axis L1 is provided. Such a vertical wall provides a hard stop to the optical fiber 67 and can damage the inserted optical fiber 67 upon contact or hamper installation of optical fiber 67 thereby increasing installation time.

As discussed below, tapered surfaces 55 are also configured to prevent lateral misalignment of optical fibers. Stated another way, tapered surfaces 55 provide a physical barrier of inserted optical fibers to prevent optical fiber crossover into a non-corresponding bore 37. This feature of tapered surfaces 55 enables accurate positioning of optical fibers 67 with the corresponding bore 37 within ferrule 16.

In particular, adjacent tapered dividers 49 have corresponding adjacent tapered surfaces 55, and as shown in FIG. 5, adjacent tapered surfaces 55 converge to form an edge 56 at second end 53. Edge 56 is configured to prevent lateral misalignment of optical fibers 67 into non-corresponding bores. Stated another way, edge 56 is configured to prevent optical fiber crossover. Edge 56 also permits passive lateral optical fiber insertion into a corresponding bore whereby an optical fiber 67 that is not aligned with corresponding bore 37 can contact edge 56 and corresponding tapered surface 55 which guide optical fiber 67 into the corresponding bore 37. In some embodiments, edges 56 can be a pointed edge where tapered surfaces 55 converge to form a linear edge. In some embodiments, edges 56 can be a rounded edge where tapered surfaces 55 converge to form a rounded edge having a radius of curvature.

Referring now to FIG. 7, an alternate embodiment of ferrule 16 is shown. As shown, ferrule 16 has a singular row of bores 37 that are coplanar with each other and includes tapered dividers 49 as discussed above. Ferrule 16 also includes a window 63 on ferrule body 17. In particular, window 63 is provided on a top side of ferrule body 17. However, in alternate embodiments, window 63 is provided on a bottom side of ferrule body 17. In an alternate embodiment, window 63 is provided on a top side and on a bottom side of ferrule body 17 as shown in FIG. 7B. Window 63 provides access to inserted optical fibers and enables an operator to view the inserted optical fibers to ensure that the corresponding optical fiber 67 is directed to the corresponding bore 37. In addition, window 63 provides access to the interior of ferrule 16 such that a bonding agent can be inserted into ferrule 16 and bores 37 upon insertion of the optical fibers as discussed below. Bonding agent 65 is configured to couple an optical fiber 67 within ferrule 16 to form a connector assembly.

Referring briefly to FIGS. 7A-7C, various examples of disposing bonding agent 65 in ferrule 16 and/or lead in section 35 are shown. Referring first to FIG. 7A, bonding agent 65 is injected into bore 37 and microhole 25 through lead in section 35. As shown, bonding agent 65 is seated substantially throughout the length of bore 37 and microhole 25 with a portion of bonding agent 65 seated beyond a rear end of bore 37 and into tapered divider 49. When optical fiber 67 is inserted into lead in section 35, tapered divider 49, and bore 37, optical fiber 67 is inserted through ferrule 16 and bonding agent 65. In another embodiment, with reference to FIG. 7B, bonding agent 65 is injected through window 63 of ferrule 16 with bonding agent 65 seated adjacent to second end 53 of tapered divider 49. In this embodiment, optical fiber 67 is inserted through lead in section 35, through bonding agent 65, and into bore 37 with bonding agent 65 on an external surface of optical fiber 67. In another embodiment, optical fiber 67 is inserted into lead in section 35 and bore 37 of ferrule 16 with bonding agent 65 on the external surface of optical fiber 67 as shown in FIG. 7C. FIGS. 7A-7C are illustrative examples of how bonding agent 65 is applied onto optical fiber 67 and within ferrule 16. However, it is within the scope of the present disclosure that alternate techniques of treating the ferrule to promote better adhesion between the optical fiber 67 and ferrule 16 may be used such as laser etching/laser treating lead in section 35 of ferrule 16 or the like (e.g., plasma treatment, etc.), for example.

Referring now to FIGS. 8A and 8B, a method of inserting optical fiber ribbons 59, 61 into ferrule 16 is shown. Referring first to FIG. 8A, ferrule 16 is provided where spacer 39 separates the two rows of bores 37 as shown, and spacer 39 is integrally formed with ferrule 16. However, spacer 39 is not flush with back end 21 of ferrule 16 as shown. Rather, spacer 39 is positioned within lead in section 35. Referring now to FIG. 8B, optical fiber ribbons 59 and 61 are inserted into lead in section 35 to align with the two rows of bores 37. To do so, the end optical fibers of optical fiber ribbons 59, 61 are aligned with indicia 51 on back end of ferrule 16 to ensure proper fiber alignment of the end fibers of optical fiber ribbons 59, 61 with the corresponding bores 37. As shown, because spacer 39 is within lead in section 35, optical fiber ribbons 59, 61 are inserted into lead in section 35 with an optical fiber spacer 57 positioned between optical fiber ribbons 59, 61. Optical fiber spacer 57 is configured to align with spacer 39 of ferrule 16 such that optical fiber ribbons 59, 61 can align with first and second groups 27, 29 of bores 37, respectively with optical fiber misalignment between groups (i.e., an optical fiber 67 for first bore 37 of group 27 is inserted into a bore 37 of second group 29, etc.). Then, upon insertion into lead in section 35, optical fiber ribbons 59, 61 engage with corresponding tapered dividers 49 that guide the optical fibers of optical fiber ribbons 59, 61 into the corresponding bores 37. Optical fibers of optical fiber ribbons 59, 61 are then advanced through bores 37 and through microholes 25 to front end 19 of ferrule 16.

Referring now to FIGS. 9A and 9B, an alternate method of inserting optical fiber ribbons 59, 61 into ferrule 16 is shown. Referring first to FIG. 9A, ferrule 16 is provided where spacer 39 separates the two rows of bores 37 as shown. Spacer 39 is integrally formed with ferrule 16 and is flush with back end 21 of ferrule 16. Referring now to FIG. 9B, optical fiber ribbons 59 and 61 are inserted into respective apertures 47 as shown such that optical fiber ribbons 59, 61 correspond to first and second groups 27, 29 of bores 37. To do so, the end optical fibers of optical fiber ribbons 59, 61 are aligned with indicia 51 on back end of ferrule 16 to ensure proper fiber alignment of the end fibers of optical fiber ribbons 59, 61 with the corresponding bores 37. Then, upon insertion into lead in section 35, optical fiber ribbons 59, 61 engage with corresponding tapered dividers 49 that guide the optical fibers of optical fiber ribbons 59, 61 into the corresponding bores 37. Optical fibers of optical fiber ribbons 59, 61 are then advanced through bores 37 and through microholes 25 to front end 19 of ferrule 16.

In some embodiments, ferrule 16 as described is not sized to be used as an MPO connector ferrule. Stated another way, ferrule 16 may be shorter and/or thinner than a standard ferrule in an MPO connector such that ferrule 16 may be incompatible with devices designed for conventional MPO connectors. To address this challenge a converter 80 is coupled to ferrule 16 such that the form factor of the resulting assembly is similar to that of a conventional MT ferrule for MPO connectors. While an MPO connector is mentioned in the above disclosure, it is within the scope of the present disclosure that this concept may be used in other suitable connector applications.

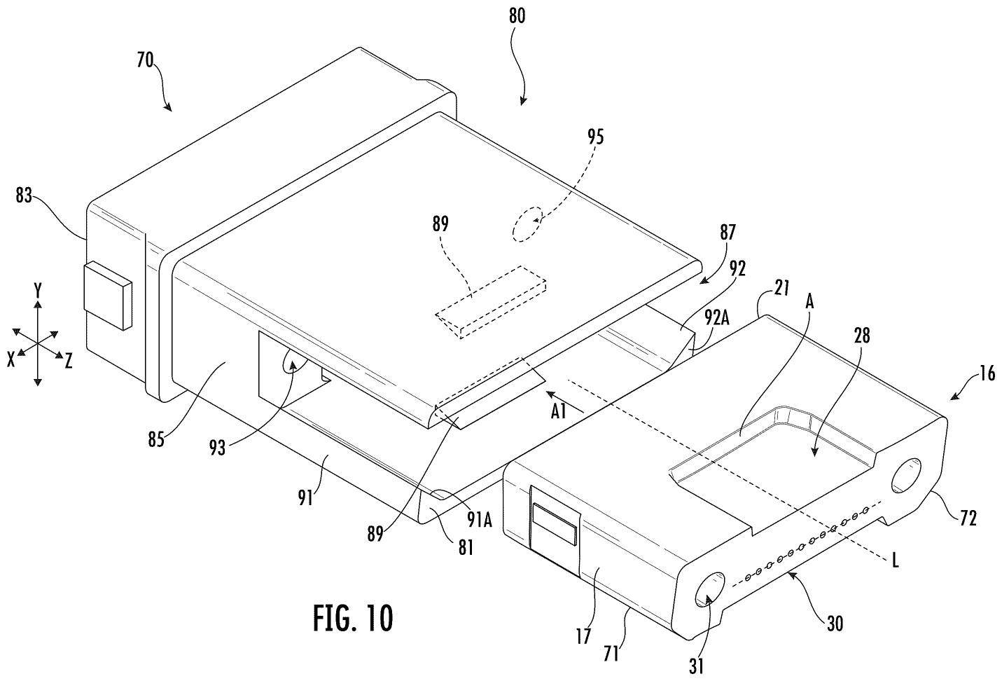

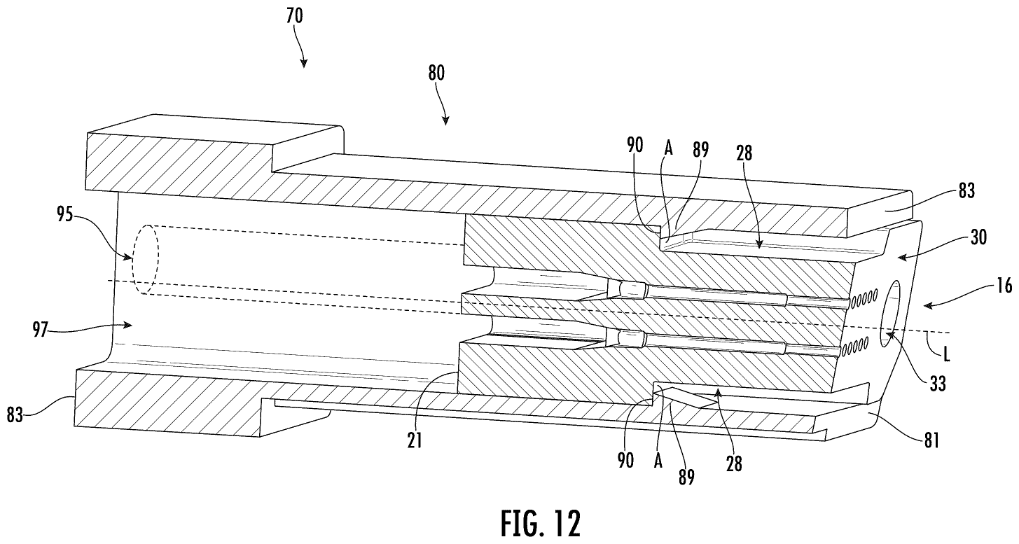

Referring now to FIGS. 10-13, a ferrule assembly 70 is shown. Ferrule assembly 70 comprises ferrule 16 as described above and converter 80. As shown, converter 80 comprises a front end 81, a back end 83, and a converter body 85.

Converter body 85 comprises an opening 87 extending between the front end 81 and the back end 83 and defined by the converter body 85. Opening 87 is configured to receive ferrule 16 between the front end 81 and back end 83 within converter body 85. Converter body 85 further comprises securing wedges 89 and side surfaces 91, 92 extending from a top section 93 and a bottom section 95 of converter body 85 and into opening 87. Securing wedges 89 and sides 91, 92 cooperate to hold ferrule 16 within converter 80.

Securing wedges 89 are configured to engage with ledge A and to extend into recessed portion 28 when coupling ferrule 16 to converter 80. In particular, to secure ferrule 16 to converter 80, ferrule 16 is advanced in direction A1 such that back end 21 advances into opening 87 first. Ferrule 16 continues to advance in direction A1 until ledge A is advanced further inward (towards back end 83 of converter 85) than securing wedges 85. At this point, securing wedges 89 are extending into recessed portion 28 of ferrule 16 and a vertical surface 90 of securing wedge 89 engages with ledge A to hold ferrule 16 in place and restrict movement in the z-direction as defined in the Cartesian coordinate system of the Figure.

As mentioned previously, securing wedges 89 and sides 91, 92 cooperate to hold ferrule within converter 80. In particular, side surfaces 91, 92 extend from front end 81 of converter 80 towards back end 83 of converter 80. Sides 91, 92 each comprise corresponding surfaces 91A, 92A that are configured to correspond to beveled edges 71, 72 of ferrule 16; surfaces 91A, 92A are spaced apart from each other by a width W that corresponds to a width of ferrule 16. As shown, surfaces 91A, 92A are angled with respect to longitudinal axis L, and surfaces 91A, 92A are angled such that the angle is the same as the angle of beveled edges 71, 72 with respect to longitudinal axis L. By having the same angle and being spaced apart by a width W, sides 91, 92 can accommodate the insertion of ferrule 16 along direction A1 into converter 80 whereby, surfaces 91A, 92A contact beveled edges 71, 72 of ferrule 16 and apply a force onto the inserted ferrule 16. In this way, side surfaces 91, 92 apply forces in the x-y plane that cooperate with the physical structure of converter 80 to limit the movement of ferrule 16 in the x-y plane as defined in the Cartesian coordinate system of the Figure.

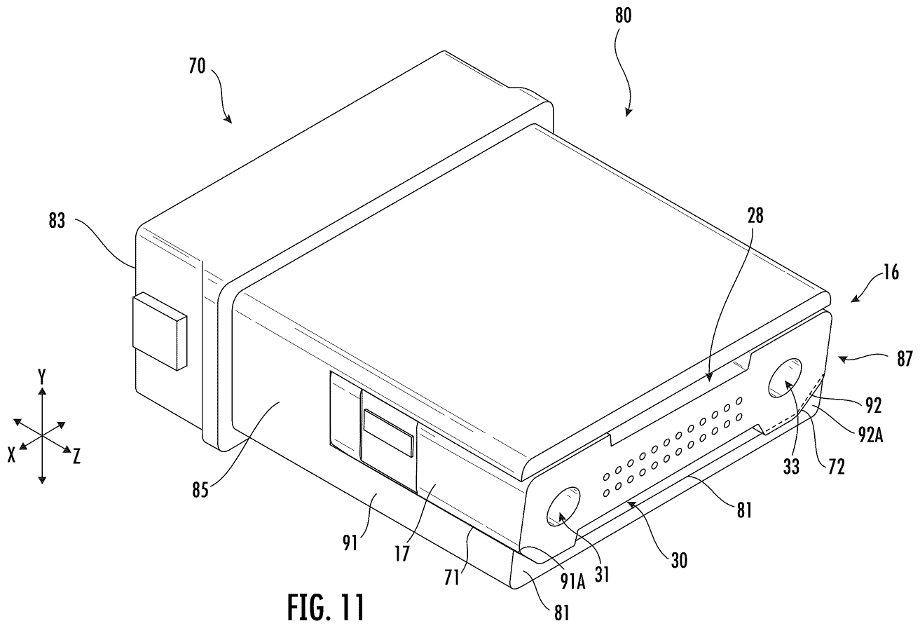

Referring briefly to FIG. 11, when ferrule 16 is inserted into converter 80, end face 30 of ferrule 16 may protrude outwardly from front end 81 of converter 80. Advantageously, such an outward protrusion enables polishing of inserted optical fibers 67 and end face 30 without affecting converter 80. Polishing of end face 30 may help achieve physical contact between inserted optical fibers 67 of mated connectors 10 by altering the geometry of end face 30 such that the angle between end face 30 and inserted optical fiber 67 is enhanced. It is within the scope of the present disclosure that in alternate embodiments, ferrule 16 could be recessed within converter 80 or end face 30 of ferrule 16 could be flush with front end 81 of converter 80.

Converter 80 further comprises pin holes 93, 95 that correspond to pin holes 31, 33 of ferrule 16 when ferrule 16 is inserted into converter 80. Pin holes 93, 95 are configured to align with pin holes 31, 33 of ferrule 16 and extend the length of pin holes 31, 33 to back end 83 of converter 80. In this way, pin holes 31, 33 can receive guide pins when mounting ferrule 16 within converter 80 and connector 10.

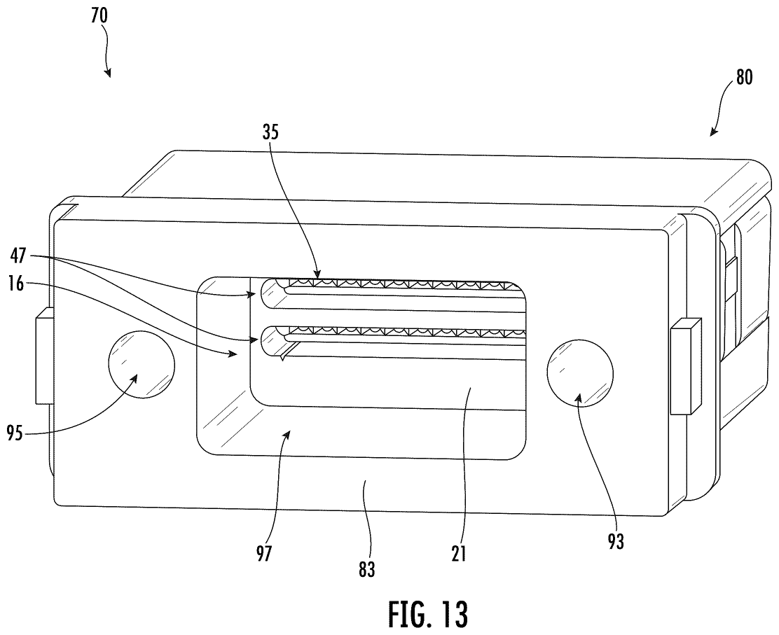

Referring briefly to FIG. 13, a rear view of ferrule assembly 70 is shown. As shown, converter 80 further comprises a lead in portion 97 extending from the back end 83 of converter 80 into opening 87 of converter 80. Lead in portion 97 is configured to provide access to back end 21 of ferrule 16 and corresponding lead in section 35 when inserting optical fibers 67 into ferrule assembly 70.

To secure converter 80 onto ferrule 16 and with reference to FIG. 10, ferrule 16 is first advanced within opening 87 of converter 80 along direction A1 such that back end 21 is proximal to lead in portion 97 of converter 80. When advancing ferrule 16 along direction A1, ferrule 16 engages with securing wedges 89 of converter 80. In particular, vertical surface 90 of securing wedges 89 engage with ledge A of ferrule 16 such that ferrule 16 and converter 80 are in snap fit engagement to form ferrule assembly 70.

After assembling ferrule assembly 70, optical fiber(s) 67 are inserted through the lead in portion 97 of converter 80 and into corresponding bore 37 of ferrule 16. In some embodiments, bonding agent 65 can be applied before, during, or after insertion of optical fiber(s) 67 into ferrule assembly 70 as discussed previously with reference to FIGS. 7A-7C to form connector 10. Polishing of connector 10 is then completed.

In an alternate embodiment, to assemble connector 10, optical fiber(s) 67 are first inserted through lead in section 97 of converter 80 and through opening 87 of converter 80. Then, bonding agent 65 is applied into bores 37 of ferrule 16 such that inserted optical fiber(s) 67 are bonded to bores 37 of ferrule 16 using any of the methods discussed above with respect to FIGS. 7A-7C. After securing the optical fibers 67 within bore 37, converter 80 is moved onto ferrule 16 such that converter 80 and ferrule 16 are in snap fit engagement with each other as discussed above. In this embodiment, polishing of end face 30 of ferrule 16 can be completed before or after the snap fit assembly of ferrule assembly 70.

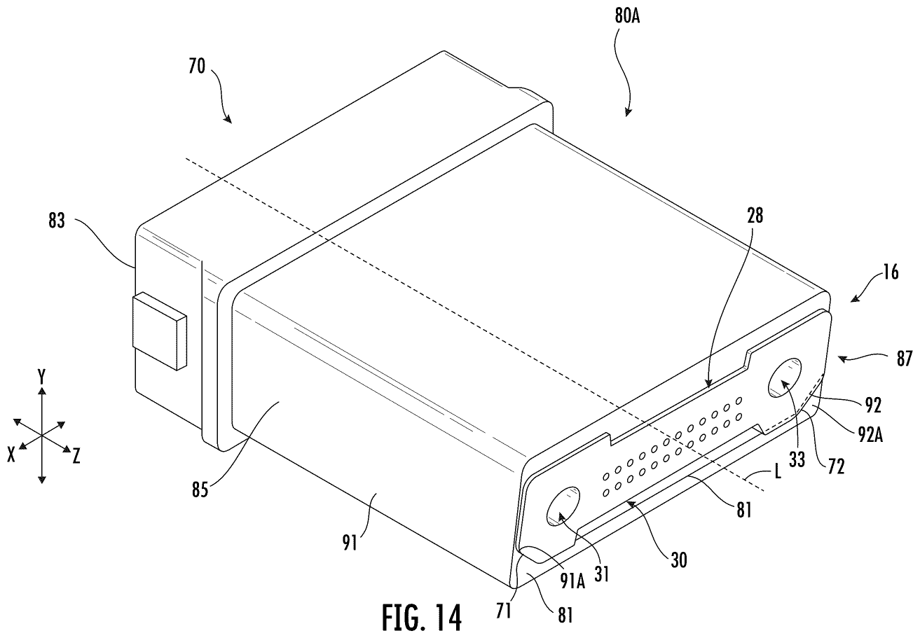

Referring now to FIGS. 14-16, an alternate embodiment of ferrule assembly 70 is shown. In the description of the alternate embodiment of ferrule assembly 70, similar components of ferrule assembly 70 between the embodiments will have the same numbering except as noted herein. In this embodiment, ferrule assembly 70 comprises a ferrule 16 as described above and a converter 80A.

Converter 80A comprises a front end 81, a back end 83, and a converter body 85 extending from the front end 81 to the back end 83. Converter body 85 comprises an opening 87 extending between the front end 81 and the back end 83 and that is defined by the shape of converter body 85. Opening 87 is configured to receive ferrule 16 between the front end 81 and back end 83 within converter body 85. Converter body 85 further comprises securing wedges 89 and side surfaces 91, 92 extending from a top section 93 and a bottom section 95 of converter body 85 and into opening 87. Securing wedges 89 and sides 91, 92 cooperate to hold ferrule 16 within converter 80.

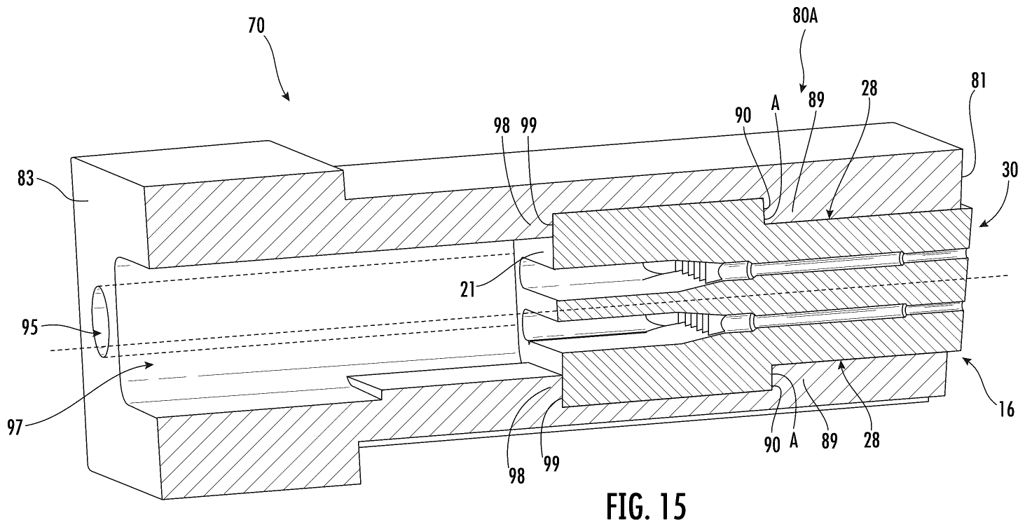

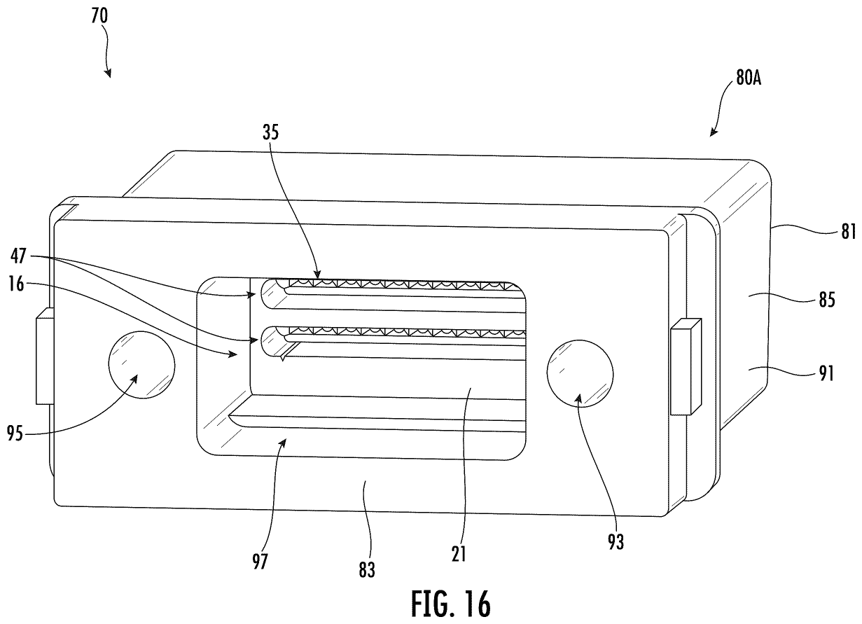

Securing wedges 89 are configured to engage with ledge A and to extend into recessed portion 28 when coupling ferrule 16 to converter 80. In particular, a vertical surface 90 of securing wedge 89 engages with ledge A to hold ferrule 16 in place and restrict movement in the z-direction as defined in the Cartesian coordinate system of the Figure. In addition, as shown, converter 80A further includes a second securing wedge 98 that contacts back end 21 of ferrule 16. In particular, second securing wedge 98 includes a vertical surface 99 that contacts back end 21 of ferrule 16. In this way, second securing wedge 98 engages with back end 21 of ferrule 16 to hold ferrule 16 in place and restrict movement in the z-direction as defined in the Cartesian coordinate system of the Figure. While a second securing wedge 98 is shown in FIGS. 15 and 16, it is within the scope of the present disclosure that in alternate embodiments, second securing wedge 98 is omitted, and auxiliary structure(s) of the overmolded converter 80A (e.g., added material surrounding pin holes 93, 95) contact back end 21 of ferrule 16 to assist in holding ferrule 16 in place within converter 80A.

To further secure ferrule within converter 80A, sides 91, 92 extend from front end 81 of converter 80 towards back end 83 of converter 80. Sides 91, 92 each comprise corresponding surfaces 91A, 92A that are configured to correspond to beveled edges 71, 72 of ferrule 16 as discussed below. In addition, surfaces 91A, 92A are spaced apart from each other by a width that corresponds to a width of ferrule 16. As shown, surfaces 91A, 92A are angled with respect to longitudinal axis L, and surfaces 91A, 92A are angled with respect to longitudinal axis L such that the angle is the same as the angle of beveled edges 71, 72. By having the same angle and being spaced apart by the width of ferrule 16, sides 91, 92 can accommodate ferrule 16 into converter 80A whereby, surfaces 91A, 92A contact beveled edges 71, 72 of ferrule 16 and apply a force onto the inserted ferrule 16. In this way, side surfaces 91, 92 apply forces in the x-y plane that cooperate with the physical structure of converter 80A to limit the movement of ferrule 16 in the x-y plane as defined in the Cartesian coordinate system of the Figure.

Referring briefly to FIG. 15, when ferrule 16 is surrounded by converter 80A, end face 30 of ferrule 16 may protrude outwardly from front end 81 of converter 80A. Advantageously, such an outward protrusion enables polishing of inserted optical fibers 67 and end face 30 without affecting converter 80A. Polishing end face 30 may help achieve physical contact between inserted optical fibers 67 of mated connectors 10 by altering the geometry of end face 30 such that the angle between end face 30 and inserted optical fiber 67 is enhanced. It is within the scope of the present disclosure that in alternate embodiments, end face 30 of ferrule 16 could be recessed within converter 80A or end face 30 of ferrule 16 could be flush with front end 81 of converter 80A.

Converter 80A further comprises pin holes 93, 95 that correspond to pin holes 31, 33 of ferrule 16 when ferrule 16 is inserted into converter 80A. Pin holes 93, 95 are configured to align with pin holes 31, 33 of ferrule 16 and extend the length of pin holes 31, 33 to back end 83 of converter 80A. In this way, pin holes 31, 33 can receive guide pins when mounting ferrule 16 within converter 80A and connector 10.

Referring briefly to FIG. 16, a rear view of ferrule assembly 70 is shown. As shown, converter 80A further comprises a lead in portion 97 extending from the back end 83 of converter 80A into opening 87 of converter 80A. Lead in portion 97 is configured to provide access to back end 21 of ferrule 16 and corresponding lead in section 35 when inserting optical fibers 67 into ferrule assembly 70.

To apply converter 80A onto ferrule 16, converter 80A is overmolded onto ferrule 16. In some embodiments, converter 80A is directly molded onto ferrule 16 in a secondary molding operation. Advantageously, by molding converter 80A onto ferrule 16, features of ferrule 16 create the bonding geometry/configuration that keep ferrule 16 and converter 80A coupled to each other during their respective lifetimes. For example, the location of ledge A and recessed portion 28 of ferrule 16 creates the geometry of converter 80A to enable converter 80A to couple to ferrule 16.

Because these and other variations, modifications, combinations, and sub-combinations of the disclosed embodiments may occur to persons skilled in the art, the invention should be construed to include everything within the scope of the appended claims and their equivalents.

What is claimed is:

1. A ferrule for an optical connector configured to accept a plurality of optical fibers, the ferrule comprising:
a body having a front end and a back end, the body extending in a longitudinal direction between the front end and the back end;
a plurality of bores extending into the body from the front end toward the back end, wherein each bore is configured to receive one of the plurality of optical fibers;
a plurality of tapered dividers wherein each tapered divider has:
a first end adjacent to a respective bore of the plurality of bores and a second end proximal to the back end of the ferrule;
a cross-sectional shape at the first end that spans a circumference of the respective bore such that each of the plurality of bores are separated from each other; and
tapered surfaces from the second end to the first end.

2. The ferrule of claim 1, wherein the back end of the ferrule includes an indicia whereby the indicia provides a visual indicator of horizontal alignment of the plurality of optical fibers within the plurality of bores of the ferrule.

3. The ferrule of claim 2, wherein the indicia extends from the back end of the ferrule to the second end of the tapered divider.

4. The ferrule of claim 1, wherein the tapered divider has a height H1 at a first end and a height H2 at the second end, wherein a height ratio H2:H1 ranges between 1.2:1 and 3:1.

5. The ferrule of claim 1, wherein the tapered divider has a width W1 at a first end and a width W2 at the second end, wherein a width ratio W2:W1 ranges between 1.2:1 and 3:1.

6. The ferrule of claim 1, wherein the tapered divider has a circular cross section at the first end and a square cross section at the second end.

7. The ferrule of claim 1, wherein the tapered surface of the tapered divider has an angle ranging between 15° and 45° relative to a longitudinal axis of one of the bores.

8. The ferrule of claim 1, wherein adjacent tapered dividers have corresponding adjacent tapered surfaces that form an edge, wherein the edge is configured to prevent an optical fiber from being inserted into a non-corresponding bore.

9. The ferrule of claim 1, wherein the second end of the tapered divider is flush with the back end of the ferrule.

10. The ferrule of claim 1, wherein the plurality of bores comprises a first row of bores and a second row of bores spaced from the first row of bores, wherein the first row of bores are coplanar with each other and the second row of bores are coplanar with each other.

11. The ferrule of claim 10, wherein the first row of bores and the second row of bores are separated by a spacer that is flush with the back end of the ferrule, and wherein the spacer is integrally formed with the ferrule.

12. The ferrule of claim 1, wherein the ferrule further comprises a window formed on a top surface or a bottom surface of the ferrule, wherein the window extends into a lead-in section of the ferrule adjacent to the tapered divider.

13. An optical connector, comprising:
a ferrule that includes:
a body having a front end and a back end, the body extending in a longitudinal direction between the front end and the back end;
a plurality of bores extending into the body from the front end toward the back end, wherein each bore is configured to receive one of the plurality of optical fibers;
a plurality of tapered dividers wherein each tapered divider has:
a first end adjacent to a respective bore of the plurality of bores and a second end proximal to the back end of the ferrule;
a cross-sectional shape at the first end that spans a circumference of the respective bore such that each of the plurality of bores are separated from each other; and
tapered surfaces from the second end to the first end; and
a plurality of optical fibers secured to the ferrule, wherein each optical fiber extends from the back end of the body and into one of the microholes.

14. The optical connector of claim 13, wherein the plurality of bores comprises a first row of bores and a second row of bores spaced from the first row of bores, wherein the first row of bores are coplanar with each other and the second row of bores are coplanar with each other.

15. The optical connector of claim 14, wherein the plurality of optical fibers comprises a first ribbon of optical fibers and a second ribbon of optical fibers, wherein the first ribbon of optical fibers and the second ribbon of optical fibers are coplanar with each other; and
wherein the first ribbon of optical fibers and the second ribbon of optical fibers are separated by an optical fiber spacer;
wherein the first ribbon of optical fibers, the second ribbon of optical fibers, and the optical fiber spacer are inserted into the back end of the ferrule such that the first ribbon of optical fibers are inserted into the first row of bores and the second ribbon of optical fibers are inserted into the second row of bores.

16. The optical connector of claim 14, wherein the first row of bores and the second row of bores are separated by a spacer that is flush with the back end of the ferrule, and wherein the spacer is integrally formed with the ferrule.

17. The optical connector of claim 16, wherein the plurality of optical fibers comprises a first ribbon of optical fibers and a second ribbon of optical fibers, wherein the first ribbon of optical fibers and the second ribbon of optical fibers are coplanar with each other; and
wherein the first ribbon of optical fibers and the second ribbon of optical fibers are inserted into the back end of the ferrule such that the first ribbon of optical fibers are inserted into the first row of bores and the second ribbon of optical fibers are inserted into the second row of bores.

18. A method of terminating a plurality of optical fibers with a ferrule that includes a body, a plurality of bores, and a plurality of tapered dividers, wherein the body has a front end and a back end and extends in a longitudinal direction between the front end and the back end, wherein the plurality of bores extend into the body from the front end toward the back end and each bore is configured to receive one of the plurality of optical fibers, and wherein each tapered divider of the plurality of tapered dividers has a first end adjacent to a respective bore of the plurality of bores and a second end proximal to the back end of the ferrule, a cross-sectional shape at the first end that spans a circumference of the respective bore such that each of the plurality of bores are separated from each other, and tapered surfaces from the second end to the first end, the method comprising:
aligning the optical fibers with the bores of the ferrule; and
extending the optical fibers through the back end of the ferrule and into the bores, wherein the tapered divider provides that one optical fiber extends through each of the bores.

19. The method of claim 18, wherein the aligning step comprises:
aligning a first ribbon of optical fibers with a first row of bores; and
aligning a second ribbon of optical fibers with a second row of bores.

20. The method of claim 19, wherein the aligning the first ribbon of optical fibers includes aligning an optical fiber of the first ribbon with an indicia on a back end of the ferrule; and
wherein the aligning the second ribbon of optical fibers includes aligning an optical fiber of the second ribbon with the indicia on the back end of the ferrule.

21. The method of claim 19, wherein the first ribbon of optical fibers and the second ribbon of optical fibers are separated by an optical fiber spacer that is inserted into the ferrule with the first ribbon of optical fibers and the second ribbon of optical fibers.

22. The method of claim 18, further comprising:
supplying an adhesive into the tapered divider.

23. The method of claim 22, wherein the adhesive is supplied to the bores through a window formed in a top surface of the ferrule and extending into a lead in section of the ferrule adjacent to the tapered divider.
